(19) United States
(12) Patent Application Publication
(10) Pub. No.: US 2017/0163497 A1
(43) Pub. Date: Jun. 8, 2017

(54) PORTABLE SPEAKER

(71) Applicant: Hewlett-Packard Development Company, L.P., Houston, TX (US)

(72) Inventor: David H. HANES, Loveland, CO (US)

(21) Appl. No.: 15/320,282

(22) PCT Filed: Jul. 7, 2014
(86) PCT No.: PCT/US14/45519

§ 371 Date: Dec. 19, 2016

(51) Int. Cl. H04L 12/24; H04W 4/00; G06F 3/16; H04L 29/06

(52) U.S. Cl. CPC H04L 41/5051; H04L 65/4084; H04W 4/008; G06F 3/167; G06F 3/0488

(57) ABSTRACT

In one example implementation, a portable speaker receives a command to automatically generate a new station with the Internet radio service provider. The portable speaker determines attribute information for the current audio output of the portable speaker, and sends a request to the Internet radio service provider to generate the new station based on the attribute information.

### BACKGROUND

A speaker is an electroacoustic transducer that produces sound in response to an input signal. In particular, a speaker converts received electrical signals into audible signals to be heard by a user located proximate to the speaker. In many cases, the audible signals correspond to music the user desires to hear. The audible signals, however, are not limited to music, and indeed often correspond to other content types such as audio books, speeches, sports programming, and the like.

Looking at the setup between the speaker and the content source (e.g., a stereo receiver), in the past, the speaker and content source were generally stationary and coupled to one another via speaker wire. Now, however, the setup has become much more flexible with the introduction of portable speakers. These portable speakers, among other things, tend to be small, lightweight, transportable, battery operated, and/or wireless-enabled. As a result, a user can, for example, move with both a portable speaker and a content source (e.g., a smartphone or tablet), and listen to audio content anywhere by wirelessly coupling the portable speaker to the content source (e.g., via a Bluetooth connection). This flexibility has caused portable speakers to gain traction in the marketplace, and it is predicted that this momentum will only continue given the prevalence of mobile computing devices.

### BRIEF DESCRIPTION OF THE DRAWINGS

Examples are described in the following detailed description and in reference to the drawings, in which:

FIG. 1 depicts an example system including a portable speaker in accordance with an implementation;

FIG. 2 depicts an example portable speaker in accordance with an implementation;

FIG. 3 depicts a process flow diagram for example portable speaker operation in accordance with an implementation;

FIG. 4 depicts a process flow diagram for example portable speaker operation in accordance with another implementation;

FIG. 5 depicts a process flow diagram for example portable speaker operation in accordance with yet another implementation; and

FIG. 6 depicts an example portable speaker in accordance with an implementation.

### NOTATION AND NOMENCLATURE

Certain terms are used throughout the following description and claims to refer to particular system components. As one skilled in the art will appreciate, technology companies may refer to components by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct electrical or mechanical connection, through an indirect electrical or mechanical connection via other devices and connections, through an optical electrical connection, or through a wireless electrical connection.

Additionally, the term “portable speaker” should be understood as a powered speaker with built-in amplifier that is intended to be easily transportable. The portable speaker communicates by at least wireless communication and a wireless protocol (e.g., the Bluetooth protocol). Example portable speakers include the Beats Pill® series, Bose SoundLink® series, and Jawbone Jambox® series, and the HP® Mini Bluetooth Speaker series. Furthermore, the term “portable computing device” is intended to refer to a computing device that is intended to be easily transportable and operated at various locations. Example portable computing devices include smartphones, tablets, notebooks, convertible/hybrid notebooks, mobile all-in-one (AiO) desktops, and/or wearable computing devices such as smart watches, smart glasses, and other smart computing apparel.

Still further, the term “Internet radio service provider” should be understood as a provider of a service that utilizes the Internet to deliver the audio content service. Examples in the context of the present disclosure include Pandora®, vTuner®, Slacker®, Deezer®, TuneIn®, Live365®, and Spotify®, to name a few. In addition, the term “metadata” should be understood as information describing the content and context of audio files. For example, metadata for an audio file may include information about the artist, genre, release date, title, duration, and/or album name. Finally, the term “web server” should be understood as hardware and/or software that stores, processes, and delivers web content accessible through the Internet. Examples include Apache HTTP server, LightSpeed, and NanoHTTPD.

### DETAILED DESCRIPTION

As mentioned above, portable speakers are gaining traction in the marketplace due to their size, portability, and ability to communicate with portable computing devices like tablets, laptops, and smartphones.

In one common use case, a user utilizes a portable computing device to obtain digital audio content from an Internet radio service provider (e.g., Pandora® or Spotify®). The user then wirelessly streams the digital audio content from the portable computing device to the portable speaker via a short range wireless protocol (e.g., the Bluetooth protocol). The speaker then outputs the sound corresponding to the digital audio content.

With particular respect to generating a station and obtaining the digital audio content from the Internet source provider, in most cases, the user has to access the Internet source provider's website (e.g., via the Internet radio service provider's application or “app”). Once on the website, the user may search for audio content based on genre, song, and/or artist. Once the desired, genre, song, and/or artist is located, the user may select it to create a station, and audio content associated with that station may be provided from the Internet radio service provider to the user's portable computing device. Once received at the portable computing device, as mentioned above, the user may wirelessly stream the content to a portable speaker for output.

While the above-mentioned approach is suitable for many use cases, there are some situations where the user may desire to create a station in a simpler, less time-intensive, and less interruptive manner. For example, the user may be listening to a station outputting 1970s music at a social gathering. The user may hear a song by Bob Dylan and desire to create a station that provides audio content related to Bob Dylan. The user, however, may not desire to spend time retrieving their computing device, searching for a Bob Dylan station, and/or creating the station. Moreover, the user may not desire to interrupt the current output of the speaker. Still further, the user may not know that the song is by Bob Dylan, and may not want to take the time to determine the artist.

Aspects of the present disclosure address at least this issue by providing a simple, intuitive, and non-interruptive approach to generate a new station with an Internet radio service provider. In particular, aspects of the present disclosure provide a novel and previously unforeseen approach to create a station associated with audio content being output by a portable speaker by providing a simple command to the portable speaker. For example, in one implementation, a portable speaker may automatically cause an Internet radio service provider to generate a new station in response to detection of a predetermined gesture, detection of a predetermined voice command, detection of a touch on a surface of the portable speaker, detection of a depression of a button on the portable speaker, and/or detection of a touch on a touch sensitive display of the portable speaker. These and other aspects of the present disclosure are discussed below with reference to various figures and examples.

In one example implementation, a portable speaker is provided. The portable speaker comprises a speaker to output sound, a communication interface to enable communication with an Internet radio service provider, and a management module to (i) receive a command to automatically generate a new station with the Internet radio service provider, wherein the new station corresponds to the current audio output of the portable speaker; (ii) determine attribute information for the current audio output of the portable speaker; and (iii) send a request to the Internet radio service provider to generate the new station based on the attribute information.

In another example implementation, a process is provided. The process comprises (i) receiving, at a portable speaker, authentication information for an Internet radio service provider; (ii) accessing, by the portable speaker, the Internet radio service provider using the authentication information; (iii) outputting, from a portable speaker, audio content received from the Internet radio service provider; (iv) receiving, at the portable speaker, a command to automatically generate a new station with the Internet radio service provider related to the audio content; (v) determining, at the portable speaker, attribute information for the audio content; and (vi) sending, by the portable speaker, a request to the Internet radio service provider to generate the new station.

In yet another example implementation, a non-transitory machine-readable medium is provided. The non-transitory machine-readable medium comprises instructions which, when executed, cause a portable speaker to (i) receive a command to automatically generate a new station with an Internet radio service provider based on audio content being output by the portable speaker; (ii) determine attribute information for the audio content being output by the portable speaker; (iii) send a request to the Internet radio service provider to generate the new station, wherein the request includes the attribute information; and (iv) output a notification indicating that the new station has been generated.

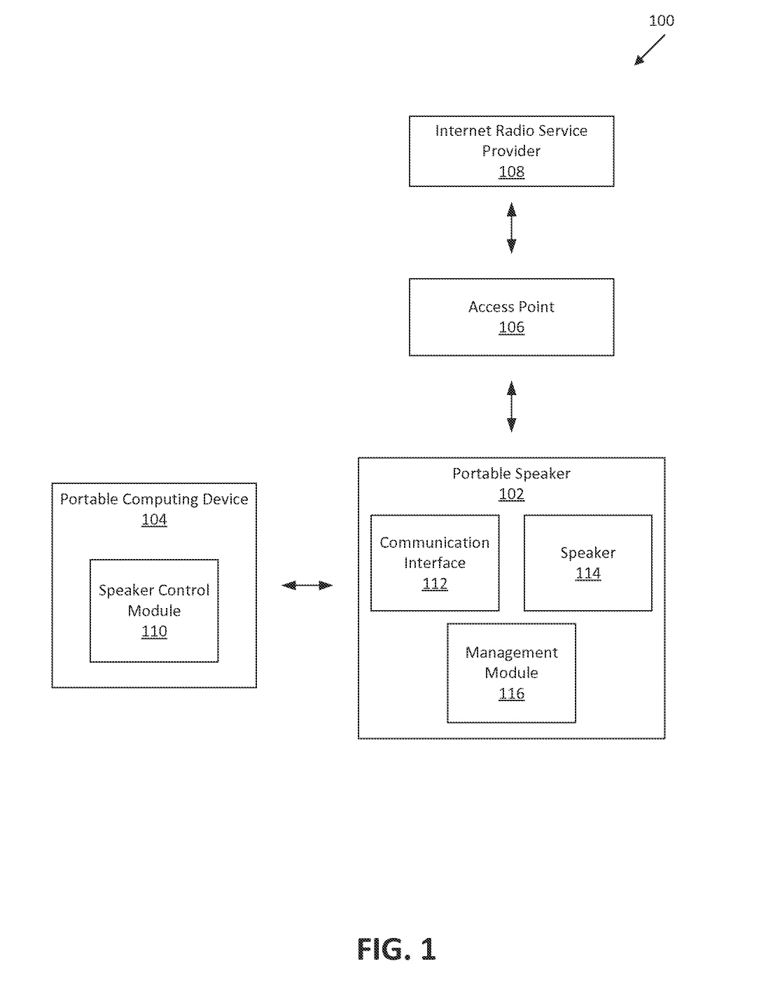

Looking now at FIG. 1, this figure depicts an example system 100 in accordance with an implementation. The system 100 comprises a portable speaker 102, a plurality of portable computing devices 104, an access point 106, and an Internet radio service provider 108.

Looking at the system 100 at a high level, the portable speaker 102 may receive a user command to automatically generate a new station related to the current output of the portable speaker 102. In response to the command (e.g., depression of a button on the portable speaker 102), the portable speaker 102 causes the Internet radio service provider 108 to generate the new station. In various examples, the portable speaker 102 may access the Internet radio service provider 108 based on previously provided authentication information received from the portable computing device 110. Once the station is created, the Internet radio service provider 108 may provide a notification to the portable speaker 102 indicating that the station has been created.

More particularly, and looking closer at each device in the system 100, the portable computing device 104 may comprise, for example, a smartphone, tablet, notebook, convertible/hybrid notebook, mobile all-in-one (AiO) desktop, and/or a wearable computing device such as a smart watch, smart glasses, and other smart computing apparel. The portable computing device 104 comprises a speaker control module 110. The speaker control module 110 may comprise a memory with machine-readable instructions stored thereon (e.g., a memory with a downloadable application stored thereon), which when executed, cause the portable computing devices 104 to conduct various functions.

Example functions performed by the portable computing device 104 include configuring the portable speaker 102 and/or providing authentication information to the portable speaker 102. This authentication information may comprise, for example, a SSID and/or password for the access point 106. Moreover, the authentication information may comprise authentication information for the Internet radio service provider 108. For example, if the Internet radio service provider 108 is Pandora® or Spotify®, the authentication information may comprise username, password, and/or other information to enable the portable speaker 102 to access the service when necessary. Such information may be stored on the portable speaker 102.

While the above describes configuring the portable speaker 102 via the speaker control module 110 on the portable computing device 104, this should not be viewed as limiting, as the portable speaker 102 may be configured via other approaches. For example, in some implementations, the portable speaker 102 includes an interface that enables configuration. This interface may comprise a display, touchscreen, and/or buttons on the portable speaker 102. Still further, the portable speaker 102 may be configured via a human interface device (e.g., a keyboard) coupled thereto.

Turning now to the portable speaker 102, the portable speaker 102 comprises a communication interface 112, a speaker 114, and a management module 116. It should be understood, however, that other components may be included such as, for example, a power module, a battery, a display, an amplifier, an audio codec, and/or other components common to portable speakers 102.

The communication interface 112 may comprise, for example, a transceiver, antenna, PHY, port, and/or other communication/interface circuitry to enable the portable speaker 102 to communicate with the portable computing device 104, the access point 106, the Internet radio service provider 108, and/or other devices, Additionally, the communication interface 112 may comprise a wired and/or wireless communication interface. More specifically, the communication interface 112 may comprise a short range wireless interface (e.g., Bluetooth, NFC, etc.), a long range wireless interface (e.g., IEEE 802.11), and/or a wired network interface (e.g., Ethernet)

The speaker 114 may comprise, for example, a full range driver, subwoofer, woofer, mid-range driver, coaxial driver, and/or tweeter. In some implementations, a combination of the aforementioned speaker types is included in the portable speaker 102.

The management module 116, in various examples, may comprise a memory with machine-readable instructions (e.g., software, firmware, etc.) stored thereon. When executed by a processing device, the instructions cause the portable speaker 102 to perform various functions described herein. In some implementations, the memory and processing device are discrete components, while in other implementations the memory and processing device are integrated in a single component. In still other implementations, the management module 118 may comprise a functionally equivalent circuit like an application specific integrated circuit (ASIC) or programmable logic device (PLO) to perform the various functions described herein.

Looking at the management module 116 functionality, as mentioned above, the management module 116 may cause the Internet ratio service provider 108 to generate a new station related to the current output of the portable speaker 102 in response to a command. More specifically, in response to a user “liking” the current audio output of the portable speaker (e.g., the user likes the song being output), the user may command to portable speaker 102 to generate a new station related to the audio output. Depending on the implementation, this command may be triggered by a predetermined gesture, a predetermined voice command, a touch on a surface of the portable speaker, a depression of a button on the portable speaker, and/or a touch on a touch sensitive display of the portable speaker.

For example, there may be a dedicated button (not shown) on the surface of the portable speaker 102 which may cause a new station to be generated when depressed. Alternatively or in addition, the portable speaker 102 may include voice recognition module which may cause a new station to be generated when a particular voice prompt is identified (e.g., the user saying “new station”). Alternatively or in addition, the portable speaker 102 may include a touch sensitive display which may cause a new station to be generated when a touch is identified on a particular portion of the touch sensitive display. Alternatively or in addition, the portable speaker 102 may include a touch sensitive surface which may cause a new station to be generated when a touch is identified on a particular portion of the portable speaker.

In addition to the above, the management module 116 may perform other operations. For example, the management module 116 may retrieve metadata for the current output of the portable speaker 102 and determine attribute information (e.g., artist, genre, release date, title, duration, and/or album name) based on the metadata. Moreover, when metadata is not associated with the current audio output, the management module 116 may cause the actual audio or lyrics to be analyzed to determine the attribute information. For example, when metadata is not present, the management module 116 may send a portion of the audio content to a service which analyzes the portion and provides back relevant attribute information. This service may be an Internet based service in various implementations.

Additionally, the management module 116 may login to or access the Internet radio service provider 108 with previously received authentication information, as discussed above. Furthermore, in response to the Internet radio service provider 108 generating a new station and providing a confirmation, the management module 116 may provide an audible and/or visual notification to the user to inform the user that the station has been created.

Turning now to other devices in FIG. 1, the access point 106 is generally a device that allows the portable speaker 102 to connect to a network such a personal area network (PAN), local area network (LAN), wide area network (WAN), and/or the Internet. The access point 106 may comprise a router and/or modem, and may interface with the portable speaker 102 via a wired/wireless connection.

As to the Internet radio service provider 108, this may be a service provider like Spotify®, Slacker®, Pandora®, Soma.fm®, or TuneIn®. As mentioned above, the user may provide authentication information such as a username and password to the portable speaker 102 in advance so the portable speaker 102 may access the Internet radio service provider 108 when necessary.

While not shown in FIG. 1, it should be understood that the portable speaker 102 may also comprise a network server. In some implementations, the network server is a web server that stores, processes, and delivers web pages. The web server enables the portable speaker 102 to be configured by a portable computing device 104 via a web-based interface. As mentioned above, such configuration may comprise providing authentication information for the access point 106 and/or for the Internet radio service provider 108. For example, the configuration information may be a username, password, and/or SSID. Depending on the implementation, the web server may be a full-featured web server (e.g., the Apache HTTP server) or a lightweight web server (e.g., LightSpeed or NanoHTTPD). Regardless of the implementation, the web server enables user-friendly configuration of the portable speaker 102 via a web-based interface. It should be understood, however, that the portable speaker 102 is not limited to this type of configuration, and, in some implementations, may be configured via buttons on the portable speaker 102 and/or via a keyboard coupled to the portable speaker 102, Moreover, it should be understood that the present disclosure is not limited to a web server, and other network services or network servers may be utilized to enable user-friendly configuration in accordance with various aspects of the present disclosure. For example, the network server may be a FTP server, DLNA server, or any other network server that utilizes a protocol/mechanism to transfer data between a server and client.

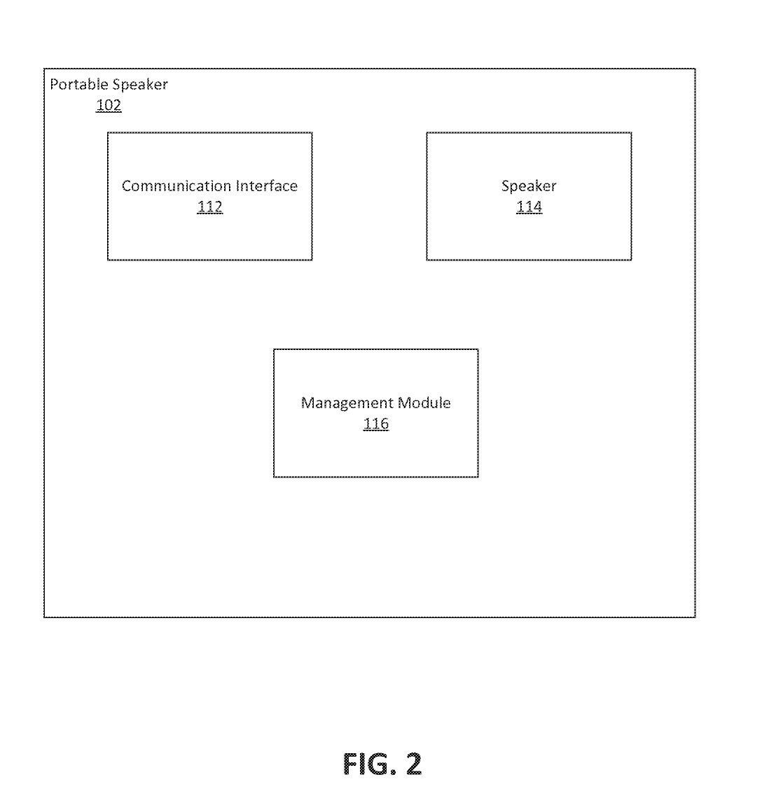

Turning now to FIG. 2, this figure depicts an example portable speaker in accordance with an implementation. As discussed above, the portable speaker 102 comprises a communication interface 112, a speaker 114, and a management module 116. As further discussed, the portable speaker may include other components like a button to cause a new station to be generated when depressed (not shown), or a touch surface/display to cause a new station to be generated when depressed (not shown), or a voice detection module to cause a new station to be generated when a particular voice prompt is spoken (not shown), or a gesture sensor to cause a new station to be generated when a particular gesture is detected (not shown).

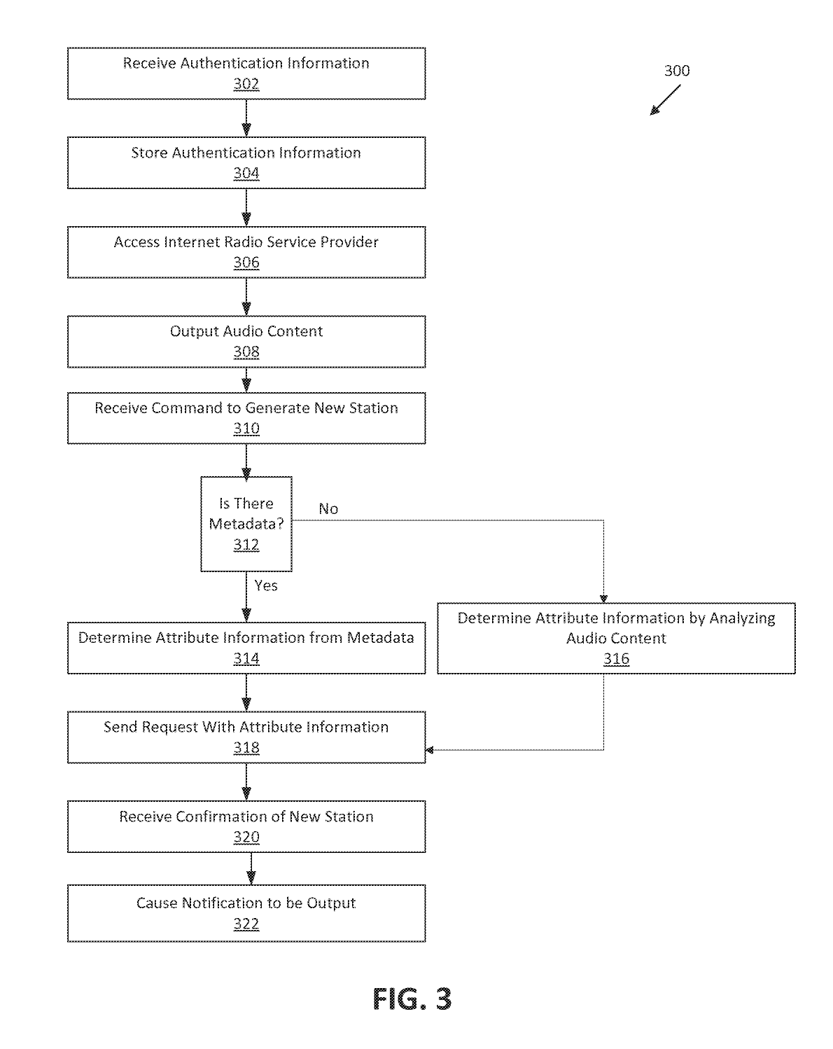

Looking now at FIG. 3, this figure depicts a process flow diagram 300 for example portable speaker 102 operation in accordance with an implementation. It should be readily apparent that the processes depicted in FIG. 3 (as well as other process flow diagrams herein) represents generalized illustrations, and that other processes may be added or existing processes may be removed, modified, or rearranged without departing from the scope and spirit of the present disclosure. In addition, it should be understood that the processes depicted may represent instructions stored on a storage medium that, when executed, may cause the portable speaker 102 to respond, to perform actions, to change states, and/or to make decisions. Alternatively or in addition, the processes may represent functions and/or actions performed by functionally equivalent circuits like analog circuits, digital signal processing circuits, application specific integrated circuits (ASICs), or other hardware components that cause the portable speaker 102 to respond, to perform actions, to change states, and/or to make decisions. Furthermore, the flow diagrams are not intended to limit the implementation of the present disclosure, but rather the flow diagrams illustrate functional information that one skilled in the art could use to design/fabricate circuits, generate software, or use a combination of hardware and software to perform the illustrated processes.

The process 300 may begin at block 302, where the portable speaker 102 receives authentication information. As mentioned above, this authentication information may be received from a portable computing device 104, from a human interface device (e.g., keyboard) coupled to the portable speaker 102, and/or from an input on an interface (e.g., touchscreen) on the portable speaker 102. As further mentioned, the authentication information may provide the portable speaker 102 access to the access point 106 and/or Internet radio service provider 108. In the case of the access point 106, the authentication information may comprise, for example, a SSID and/or password for the access point 106. In the case of the Internet radio service provider 108, the authentication information may comprise, for example, a username, email address, and/or password to gain access to the service.

Regardless of the type of authentication information, this information may be received by the portable speaker 102 and, at block 304, stored on a memory therein. This memory may be associated with the above-discussed management module 116, or may be a separate component, depending on the implementation.

At block 306, the portable speaker 102 may access the Internet radio service provider 108. For example, the portable speaker 102 may utilize a portion of the authentication information (e.g., SSID and password) to connect to the access point 106, and once connected, the portable speaker 102 may use another portion of the authentication information (e.g., username and password) to access the Internet radio service provider 108.

Once the portable speaker 102 has accessed the Internet radio service provider 108, the portable speaker 102 may begin receiving audio content from the Internet radio service provider 108. This audio content may be selected and sent based on, for example, a current user station selection or a prior user station selection (e.g., the station the user was listening to during the user's prior session). This station selection may occur, for example, via an interface on the portable speaker 102 or via the portable computing device 104. Upon receiving the audio content, at block 308, the portable speaker 102 outputs the audio content (e.g., music, talk radio, news, etc.).

While the portable speaker 102 is outputting audio content, at block 310, the portable speaker may receive a command to generate a new station. For example, the portable speaker 102 may be playing songs from a 1970s station, and in particular a song by Bob Dylan. The user may enjoy the song and like to create another station that provides songs related to Bob Dylan. The user may therefore provide a command to the portable speaker 102 to create a station. This command may be triggered by, for example, the user depressing a button on the portable speaker 102, the user doing a specific hand gesture, the user speaking a particular voice prompt, the user touching a particular portion of the portable speaker 102, and/or the user pressing a soft button on a touch interface of the portable speaker 102.

Upon receiving the command to generate a new station, at block 312, the portable speaker 102 checks if there is metadata associated with the current audio output. Such metadata may be provided by the Internet radio service provider 108 along with the audio content in various implementations. The metadata may include, for example, attribute information such as artist information, genre information, release date information, title information, duration information, and/or album name information.

If such metadata is present, at block 312, the portable speaker 102 determines attribute information for the current audio output. For example, the portable speaker 102 may determine from the metadata attribute information for the Bob Dylan song such as album name (e.g., Desire), release date (e.g., Jan. 5, 1976), song name (e.g., Isis), genre (e.g., rock), artist (e.g., Bob Dylan), and/or song duration (e.g., 6:59).

If, on the other hand, metadata is not present, at block 316, the portable speaker 102 may determine the attribute information based on lyrical analysis of the current audio output. For example, the portable speaker 102 may utilize an analysis service such as Shazam® to analyze the audio content and provide attribute information. More specifically, the portable speaker 102 may provide a sample or portion of the audio content to the analysis service and receive attribute information from the analysis service. In various implementations, the analysis service may be accessible via the Internet, and therefore the portable speaker 102 may utilize its communication interface 102 and connection with the access point 106 to access the analysis service, to provide the audio sample, and to receive the attribute information.

At block 318, after obtaining the attribute information, the portable speaker 102 generates a new station request which includes the attribute information and sends the new station request to the Internet radio service provider 108 via the communication interface 112 and access point 106. The portable speaker 102 may send this request without interrupting the current output of the portable speaker 102. Moreover, the portable speaker 102 may utilize an application program interface (API) of the Internet radio service provider 108 to communicate with the Internet radio service provider 108.

Upon receipt of the new station request, the Internet radio service provider 108 generates a new station based on the attribute information, and this new station may be added to the list of stations associated with the user's account. The Internet radio service provider 108 may then send a confirmation to the portable speaker 102 indicating that the requested station has been generated. At block 320, the portable speaker 102 receives the confirmation via the access point 106 and communication interface 112. At block 322, the portable speaker causes a notification to be output to inform the user that the requested station was indeed generated. This notification may an audible and/or visual notification on the portable speaker 102. Alternatively or in addition, the notification may be sent to the user's portable computing device 104 and an audible and/or visual notification may be provided by the portable computing device 104.

Among other things, the above-discussed approach enables a user to generate a new station with an Internet service provider 108 by simply providing a command to a portable speaker. When compared with conventional approaches for creating stations, this approach is at least simpler, faster, and less-interruptive.

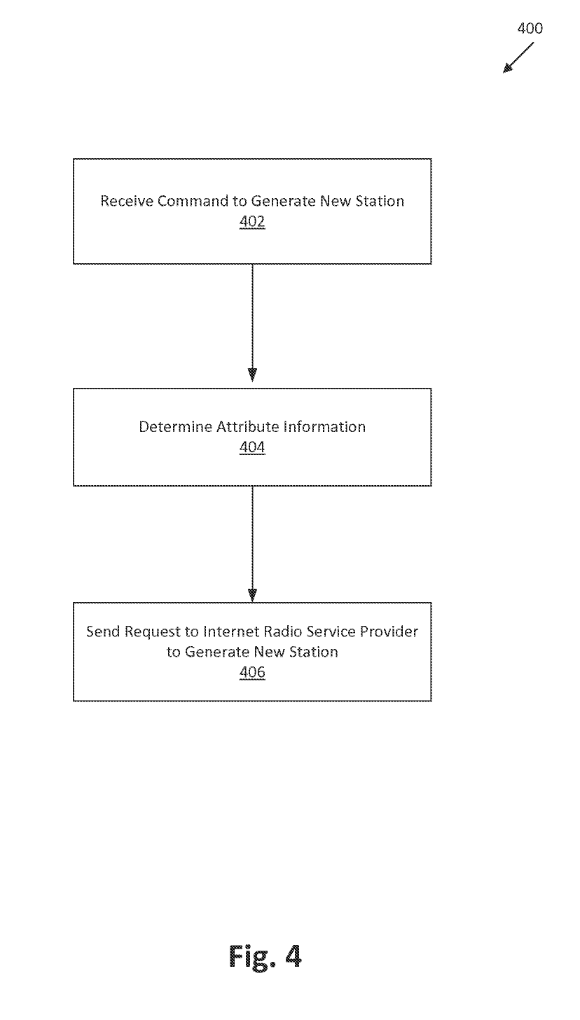

Turning now to FIG. 4, this figure depicts a process flow diagram 400 for example portable speaker operation in accordance with another implementation. The process 400 may begin at block 402 where the portable speaker 102 receives a command to generate a new station. As mentioned above, the new station is to correspond to the current audio output of the speaker. This audio output may originate from the Internet radio service provider, as discussed with respect to FIG. 3. Alternatively, the audio output may originate from another source. For example, the audio output may originate from audio content stored on a home server, stored on the portable speaker, stored on the portable computing device 104, stored on a portable memory device, or the like. With regard to communication, the portable computing device 104 may communicate with these content sources via the Digital Living Network Alliance (DLNA) standard, Samba, or any other file transfer protocol, for example. With regard to file types, the audio file may be .mp3, .flac, .ogg, .wav, and/or .wma, for example.

Regardless of the where the audio content originates from, at block 404, the portable speaker 102 determines attribute information using the above described techniques. At block 406, the portable speaker 102 sends a request to the Internet radio service provider 108 to generate a new station.

In summary, while a new station is generated with the Internet radio service provider 108, the current audio output of the portable speaker does not have to originate from the Internet radio service provider 108, For example, the user may provide audio content to the portable speaker from a home server or computer. In response to enjoying particular content, the user may provide a command to the portable speaker 102 to connect to and access the Internet radio service provider 108 based on previously provided credentials, and cause the Internet radio service provider 108 to generate a new station related to the current audio output which originated from the home server or computer.

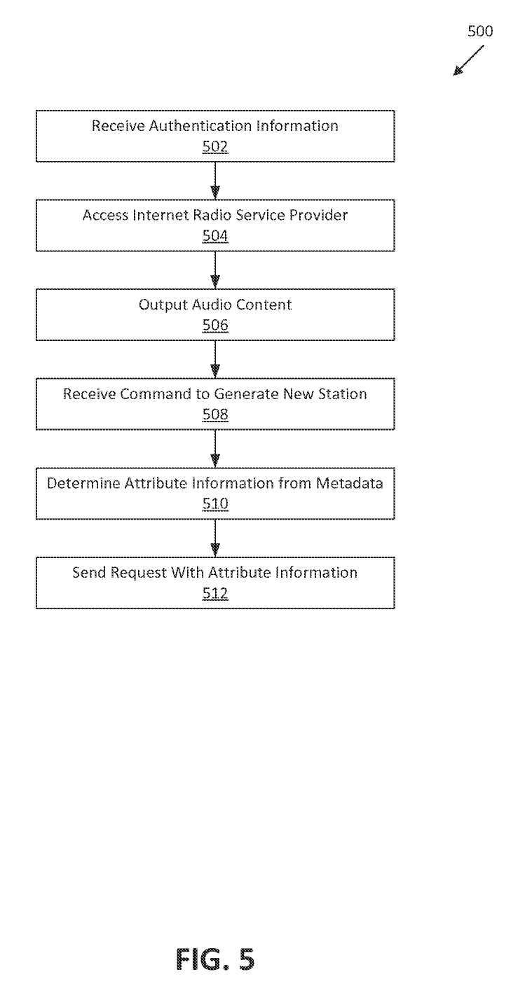

Looking now at FIG. 5, this figure depicts a process flow diagram 500 for example portable speaker operation in accordance with yet another implementation. The process 500 may begin at block 502 where the portable speaker 102 receives authentication information. As mentioned, the authentication information may comprise SSID and password information for the access point 106. Moreover, the authentication information may comprise username and password information for the Internet radio service provider 108.

At block 504, the portable speaker 102 accesses the Internet radio service provider 108. This process may comprise, for example, the portable speaker 102 providing the authentication information to the Internet radio service provider 108 via an API. At block 506, the portable speaker 102 outputs received audio content. As mentioned, this audio content may originate from the Internet radio service provider 108 or may originate from another source like a local server, computer, and/or storage device. At block 508, the portable speaker 102 receives a command to automatically generate a new station with the Internet radio service provider 108, where the new station is to correspond to the current audio output of the portable speaker 102. As mentioned above, the command may be triggered by at least one of detection of a predetermined gesture, detection of a predetermined voice command, detection of a touch on a surface of the portable speaker, detection of a depression of a button on the portable speaker, and detection of a touch on a touch sensitive display of the portable speaker.

At block 510, in response to the command to generate a new station, the portable speaker 102 determines attribute information from metadata associated with the current audio output. Then, at block 512, the portable speaker 102 sends a request to generate a new station to the Internet radio service provider 108, where the request includes at least a portion of the determined attribute information. Upon receiving the request, the Internet radio service provider 108 generates the requested station.

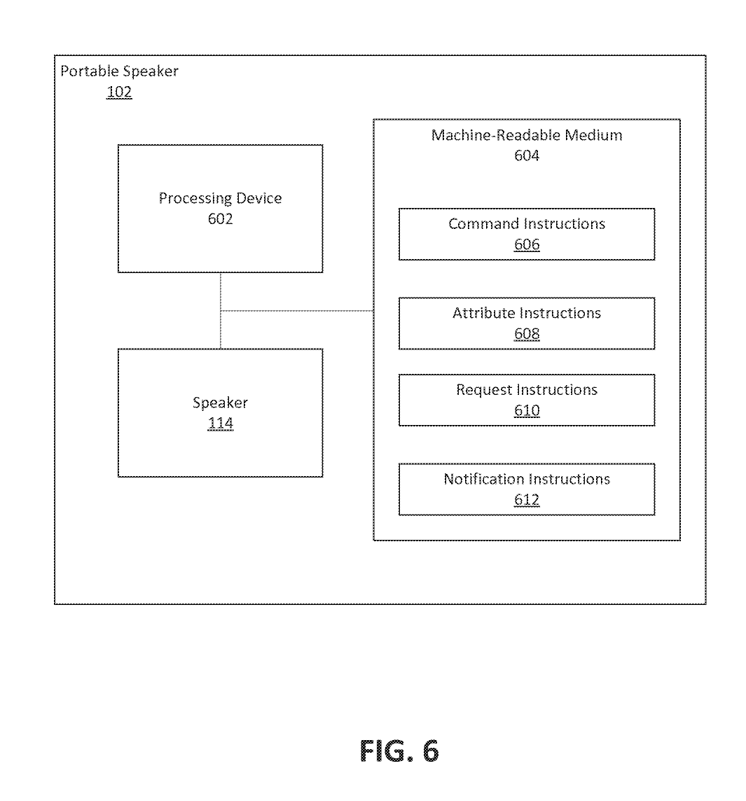

Turning to FIG. 6, this figure depicts an example portable speaker 102 in accordance with an implementation. More particularly, FIG. 6 depicts a portable speaker 102 with a speaker 114, a non-transitory machine-readable medium 604, and a processing device 602. The processing device 602 may be at least one of a microprocessor, central processing unit (CPU), microcontroller, graphic processing unit (GPU), semiconductor-based microprocessor, and/or another processing device to retrieve and execute instructions. The instructions are stored on the non-transitory machine-readable medium 604. The machine-readable medium 604 may correspond to any typical storage device that stores instructions, such as programming code or the like. For example, the machine-readable medium 604 may include one or more of a non-volatile memory, a volatile memory, and/or a storage device. Examples of non-volatile memory include, but are not limited to, electronically erasable programmable read only memory (EEPROM), read only memory (ROM), flash memory, ferroelectric RAM (F-RAM), magnetoresistive RAM (MRAM), and memristor based memory. Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices. In some implementations, the instructions may be part of an installation package that may be executed by the processing device 602. In this case, the machine-readable medium 602 may be a portable medium such as a CD, DVD, or flash drive or a memory maintained by a server from which the installation package can be downloaded and installed. In another implementation, the instructions may be part of an application already installed on the portable speaker 102. In some implementations, the processing device 602 and machine-readable medium 604 may be integrated into a single component, while in other implementations, the processing device 602 and machine-readable medium 604 may be discrete components within the portable speaker 102. Furthermore, in some implementations, the management module 116 discussed with respect to FIG. 1 comprises the machine-readable medium 604 and processing device 602, while in other implementations the management module 116 comprises functionally equivalent circuitry to perform various actions described herein.

As shown in FIG. 6, the machine-readable medium 604 comprises various machine-readable instructions 606-612. These instructions, when executed by the processing device 602, cause the portable speaker 102 to perform various actions. For example, the command instructions 606, when executed, cause the portable speaker 102 to receive a command to automatically generate a new station with an Internet radio service provider based on audio content being output by the portable speaker. The attribute instructions 608, when executed, cause the portable speaker 102 to determine attribute information for the audio content being output by the portable speaker 102. The request instructions 610, when executed, cause the portable speaker 102 to send a request to the Internet radio service provider 108 to generate the new station, wherein the request includes the attribute information. The notification instructions 612, when executed, cause the portable speaker 102 to output a notification indicating that the new station has been generated.

The foregoing describes a simple, intuitive, and non-interruptive approach to generate a new station with an Internet radio service provider directly from a portable speaker. In particular, aspects of the present disclosure provide a novel and previously unforeseen approach to create a station associated with audio content being output by a portable speaker by providing a simple command to the portable speaker. While the above disclosure has been shown and described with reference to the foregoing examples, it should be understood that other forms, details, and implementations may be made without departing from the spirit and scope of the disclosure that is defined in the following claims.

What is claimed is:

1. A portable speaker comprising:
a speaker to output sound;
a communication interface to enable communication with an Internet radio service provider; and
a management module to
receive a command to automatically generate a new station with the Internet radio service provider, wherein the new station corresponds to the current audio output of the portable speaker;
determine attribute information for the current audio output of the portable speaker; and
send a request to the Internet radio service provider to generate the new station based on the attribute information.

2. The portable speaker of claim 1, wherein the command is triggered by at least one of (i) detection of a predetermined gesture, (ii) detection of a predetermined voice command, (iii) detection of a touch on a surface of the portable speaker, (iv) detection of a depression of a button on the portable speaker, and (v) detection of a touch on a touch sensitive display of the portable speaker.

3. The portable speaker of claim 1, wherein the management module is further to:
access the Internet radio service provider with previously received authentication information.

4. The portable speaker of claim 1, wherein the attribute information comprises at least one of artist, genre, and album information.

5. The portable speaker of claim 1, wherein the management module is further to:
determine the attribute information based on metadata associated with the current audio output of the portable speaker.

6. The portable speaker of claim 1, wherein the management module is further to:
determine the attribute information based on lyrical analysis of the current audio output of the portable speaker.

7. The portable speaker of claim 1, wherein the management module is further to:
receive an indication that the new station has been generated; and
cause a notification to be output indicating that the new station has been generated.

8. The portable speaker of claim 1, wherein the current audio output of the portable speaker is not provided by the Internet radio service provider.

9. A method comprising:
receiving, at a portable speaker, authentication information for an Internet radio service provider;
accessing, by the portable speaker, the Internet radio service provider using the authentication information;
outputting, from a portable speaker, audio content received from the Internet radio service provider;
receiving, at the portable speaker, a command to automatically generate a new station with the Internet radio service provider related to the audio content;
determining, at the portable speaker, attribute information for the audio content; and
sending, by the portable speaker, a request to the Internet radio service provider to generate the new station.

10. The method of claim 9, further comprising:
storing the authentication information at the portable speaker, wherein the authentication information is received from a portable computing device.

11. The method of claim 9, wherein the command is triggered by at least one of (i) detection of a predetermined gesture, (ii) detection of a predetermined voice command, (iii) detection of a touch on a surface of the portable speaker, (iv) detection of a depression of a button on the portable speaker, and (v) detection of a touch on a touch sensitive display of the portable speaker.

12. The method of claim 9, further comprising:
receiving, at the portable speaker, an indication that the new station has been generated; and
causing, by the portable speaker, a notification to be output indicating that the new station has been generated.

13. A non-transitory machine-readable medium comprising instructions which, when executed, cause a portable speaker to:
receive a command to automatically generate a new station with an Internet radio service provider based on audio content being output by the portable speaker;
determine attribute information for the audio content being output by the portable speaker;
send a request to the Internet radio service provider to generate the new station, wherein the request includes the attribute information; and
output a notification indicating that the new station has been generated.

14. The non-transitory machine-readable medium of claim 13, wherein the notification comprises at least one of a visual and audible notification.

15. The non-transitory machine-readable medium of claim 13, wherein the instructions, when executed, further cause the portable speaker to send authentication information to the Internet radio service provider.
